(19) United States
(12) Patent Application Publication
(10) Pub. No.: US 2012/0113361 A1
(43) Pub. Date: May 10, 2012

(54) Optical Level Composite Pressure-Sensitive Adhesive and an Apparatus Therewith

(75) Inventors: Jun-Yao Huang, Tonten Township (TW); Po-Pin Hung, Jingcheng Township (TW)

(73) Assignee: TPK TOUCH SOLUTIONS INC.

(21) Appl. No.: 12/943,009

(22) Filed: Nov. 10, 2010

(51) Int. Cl. G02F 1/1335; G06F 3/041; B32B 17/10; B32B 27/28; B32B 27/30; B32B 7/02

(52) U.S. Cl. 349/96; 428/482; 428/214; 428/429; 428/431; 428/447; 345/173

(57) ABSTRACT

The present invention is directed to an optical level composite pressure-sensitive adhesive (PSA), which includes a first portion and a second portion, which have different crosslinked densities and together form a mono-composite structure. The first portion and the second portion may be respectively bonded to a first lamination layer and a second lamination layer that are heterogeneous to each other. Accordingly, different interfacial adhesion and bulk rheology are generated at the interface of the first portion/first, lamination layer and the interface of the second portion/second lamination layer.

### BACKGROUND OF THE INVENTION

1. Field of the Invention

The present invention generally relates to pressure-sensitive adhesive (PSA), and more particularly to an optical level composite PSA adaptable to an apparatus such as a touch apparatus, a display apparatus or a touch-display screen.

2. Description of Related Art

A touch-display screen incorporates both touch technology and display technology, and has been widely used in electronic devices as an input and display device. FIG. 1A shows a side-view stacking diagram of conventional touch-display screen, which includes a display module 10, a touch module 12 and, a ring 11. The ring 11 is disposed between the display module 10 and the touch module 12, and is used to prevent light and dust from entering the space between the display module 10 and the touch module 12. The air medium confined within the ring 11 has a refractive index different from those of the display module 10 and the touch module 12, therefore partially causing, light reflection. As a result, light transmittance is disadvantageously reduced and image contrast is affected.

In order to improve the above disadvantages, structure as illustrated in FIG. 113 is disclosed. Specifically, an optical level pressure-sensitive adhesive (PSA) 13 replaces the ring 11 (FIG. 1A) and the air medium. Pressure-sensitive adhesives are viscoelastic materials that can provide a bonding force by a light contact pressure and a short contact time The bonding force may be utilized to bond two homogeneous optical modules such as the touch module 12 and the display module 10 composed of glass. The structure shown in FIG. 1B can improve the light transmittance and the image contrast.

Regarding two heterogeneous optical modules to be bonded such as the touch modules 12 and a polarizer 14 as shown in FIG. 1C, where the polarizer 14 and the display module 10 together form a display apparatus, the touch module 12 and the polarizer 14 are made of heterogeneous materials respectively. For example, a lamination layer of the touch module 12 is made of glass, and a lamination layer of the polarizer 14 is made of plastic. The PSA 13 used to bond the touch module 12 and the polarizer 14 will encounter some problems. Specifically, the polarizer 14 is composed of a Triacetyl cellulose (TAC) film 14A, a Polyvinyl alcohol (PVA) film 14B and a TAC film 14C. However, PVA molecules of the PVA film 14B may generate relaxation deformation along an arbitrary direction according to heat and humidity, therefore causing shrinkage of the polarizer 14, which further results in stretching bubbles at the bonding interface between the PSA 13 and the glass surface of the touch module 12. Moreover, outgassing substance of water molecules or external low molecular-weight substance may enter the PSA 13 and destroy its net structure in optical adhesive, therefore degrading its adhesiveness or even causing de-lamination.

In order to improve the bubbles and outgassing, material characteristics of the PSA 13 are modified, for example, by increasing molecular weight, crosslinked density or deformation resistance of molecular chain in the PSA. However, the modified PSA 13 has difficulty of releasing internal stress because of high cohesive strength. In other words, the modified PSA 13 lacks stress relaxation capacity and probably results in mura phenomenon. Various problems caused by the polarizer and details of stress relaxation property may be referred to a disclosure entitled “Effect of the Stress Relaxation Property of Acrylic Pressure-Sensitive Adhesive on Light-Leakage Phenomenon of Polarizer in Liquid Crystal Display,” Journal of Applied Polymer Science, Vol. 106, 2746-2752 (2007), by Hyunaee Chun, the disclosure of which is hereby incorporated by reference.

Another scheme for improving the bubbles and outgassing is accomplished through process. For example, heating or vacuum equipment may be directed at the PSA to increase its wettability. Nevertheless, this, scheme cannot effectively solve the problem, and will increase cost and processing time.

A further scheme for improving the bubbles and outgassing is achieved by using a multi-layer PSA 16, as shown in FIG. 1D, which includes a first PSA layer 16A, a backing (or optical compensation) layer 16B and a second PSA layer 16C. Such multi-layer PSA is disclosed in US Patent Application 2007/0110941 and U.S. Pat. No. 5,795,650. Although the multi-layer PSA 16 improves the bubbles and outgassing, it complicates the process and affects light transmittance and color performance.

For the foregoing reasons, a need has arisen to propose a novel optical level PSA, utilized to improve bubbles, outgassing, mura phenomenon and light transmittance.

### SUMMARY OF THE INVENTION

In view of the foregoing, it is an object of the present invention to provide an optical level composite pressure-sensitive adhesive that is capable of effectively improving bubbles and outgassing without incurring additional cost arid process time, and do not cause mura phenomenon and degrading in light transmittance.

According to one embodiment, an optical level composite pressure-sensitive adhesive (PSA) includes a first portion and a second portion. The first portion and the second portion together form a mono-composite structure, and the first portion has a crosslinked density greater than a crosslinked density of the second portion. The first portion and the second portion may be bonded to a first lamination layer and a second lamination layer respectively that are heterogeneous to each other.

The embodiment may be adapted as a touch apparatus, which includes a touch substrate and a cover lens. A composite PSA is bonded between the cover lens and the touch substrate.

The embodiment may be adapted as a display apparatus, which includes at least one polarizer and display module. A composite PSA is bonded, between the polarizer and the display module. A touch layer may be further disposed on a surface of a cover lens (i.e., touch-on-lens display apparatus), on a surface of the display module (i.e., an on-cell display apparatus) or in the display module (i.e., an in-cell display apparatus).

The embodiment may be adapted as touch-display screen, which includes a touch apparatus and a display apparatus. A composite PSA is bonded between the touch apparatus and the display apparatus.

### BRIEF DESCRIPTION OF THE DRAWINGS

Many aspects of the present structure and manufacture method can be better understood with reference to the following drawings. The components in the drawings are not necessarily to scale, emphasis instead being placed upon clearly illustrating the principles of the present disclosures. Moreover, in the drawings, like reference numerals designate corresponding parts throughout the several views.

FIG. 1A shows a side-view stacking diagram of a conventional touch-display screen;

FIG. 1B shows a side-view stacking diagram of a conventional touch-display screen that applies pressure-sensitive adhesive (PSA);

FIG. 1C shows a side-view stacking diagram of another conventional touch-display screen that applies the PSA;

FIG. 1D shows a side-view stacking diagram of a conventional touch-display screen, that uses a multi-layer PSA;

FIG. 2A show a side-view stacking diagram of a composite PSA and its bonded first/second lamination layers according to the embodiment of the present invention;

FIG. 2B shows a specific embodiment of FIG. 2A;

FIG. 2C shows another specific embodiment of FIG. 2A;

FIG. 3A shows a side-view stacking diagram of a touch-display screen according to a first exemplary application of the present invention;

FIG. 3B shows a detailed side-view stacking diagram of a touch-display screen according to the first exemplary application of the present invention;

FIG. 3C shows a side-view stacking diagram of a touch apparatus according to the first exemplary application of the present invention, and further shows an ink layer in FIG. 3A;

FIG. 4A shows a side-view stacking diagram of a touch-display screen according to a second exemplary application of the present invention;

FIG. 4B shows a side-view stacking diagram of a first alternative exemplary application in place of FIG. 4A; and

FIG. 4C shows a side-view stacking diagram of a second alternative exemplary application in place of FIG. 4A.

### DETAILED DESCRIPTION OF THE INVENTION

The detailed description of the present invention will be discussed in the following embodiments, which are not intended to limit the scope of the present invention, but can be adapted for other applications. While drawings are illustrated in details, it is appreciated that the quantity of the disclosed components may be greater or less than that disclosed, except expressly restricting the amount of the components.

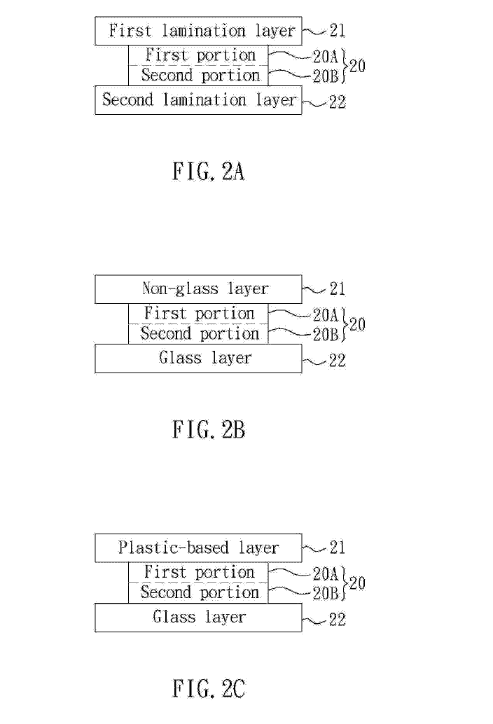

FIG. 2A shows a side-view stacking diagram of an optical level composite pressure-sensitive adhesive (PSA) 20 according to one embodiment of the present invention. Two sides of the composite PSA 20 are bonded to a first transparent lamination layer 21 and a second transparent lamination layer 22 respectively. In this specification, “optical level” indicates that the composite PSA 20 is light transparent, and its refractive index approximates the refractive index of the lamination layer. For example, glass generally has a refractive index of 1.5. Further, in this specification, “PSA” is a viscoelastic material that can provide a bonding force (or adhesion force) by a light contact pressure (e.g., by a roller). The bonding force may be utilized to bond the composite PSA 20 to the lamination layer (such as the first lamination layer 21 and the second lamination layer 22). Except for otherwise stated, the “composite PSA” in the specification refers to the adhesive disclosed in the embodiment, and “PSA” refers to the conventional adhesive. Although activation mechanism (e.g., heating, ultraviolet irradiation or solvent addition) is not necessary in generating the bonding force, the activation mechanism, however, may be used as an auxiliary means. Although a touch-display screen will be demonstrated in the embodiment, the composite PSA may be adapted to a variety of optical apparatus. The demonstrated stacking diagram is only for illustrated purpose, and the composing layers are not necessarily to scale. The orientation “top” referred in the specification is directed to the touch apparatus, and “bottom” to the display apparatus.

In the embodiment, the first lamination layer 21 and the second lamination layer 22 are made of materials having different phases. In other words, they are made of heterogeneous materials. For example, the first lamination layer 21 and the second lamination layer 22 have respective physical, chemical or surface structural characteristics. In a specific embodiment, as shown in FIG. 2B, the second lamination layer 22 is a glass layer, and the first lamination layer 21 is a non-glass layer. In another specific embodiment, as shown in FIG. 2C, the second lamination layer 22 is a glass layer, and the first lamination layer 21 is a plastic-based layer.

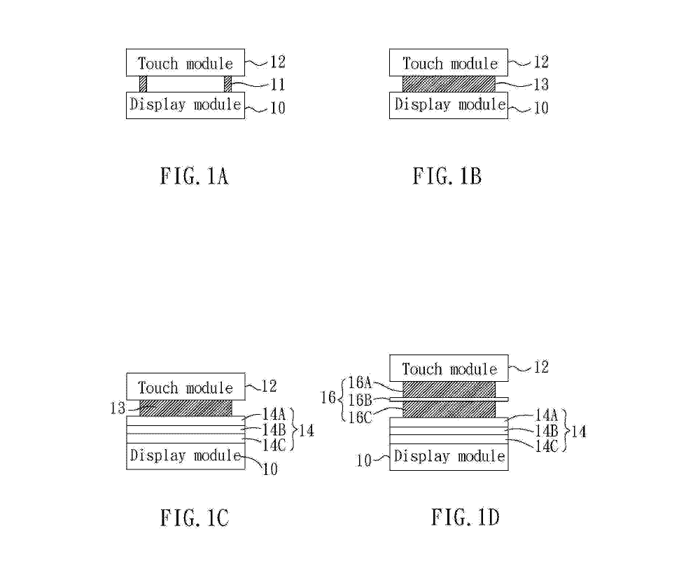

The composite PSA 20, in the embodiment, includes two portions: a fist portion 20A contacted with the first lamination layer 21, and a second portion 20B contacted with the second lamination layer 22. Specifically, the first portion 20A and the second portion 20B have different crosslinked densities respectively; and they together form, a mono-composite structure without an apparent interface or interlayer between them. Therefore, the composite PSA 20 is dramatically different from the conventional multi-layer PSA (16, FIG. 1D). Generally speaking, the composite PSA 20 of the embodiment may be manufactured by, but not limited to, firstly coating the first portion 20A and the second portion 20B of adhesive material in turn, followed by curing the first portion/second portion 20A/20B. As the first portion 20A has a crosslinked density different from that of the second portion 20B, they can generate different interfacial adhesion and bulk rheology at an interface of the first portion/first lamination layer 20A/21 and at an interface of the second portion/second lamination layer 20B/22. Quantitative and qualitative descriptions of the PSA adhesion may be referred to a disclosure entitled “Molecular Structure, Mechanical Behaviour and Adhesion Performance of Pressure Sensitive Adhesives,” by Albrecht Zosel, the disclosure of which is hereby incorporated by reference.

Take the specific embodiment of FIG. 2C as an example, the crosslinked density of the first portion 20A of the composite PSA 20 is greater than the crosslinked density of the second portion 20B. Generally speaking, the value of the crosslinked density can be indirectly measured by a modulus detection (such as a storage modulus detection) under dynamic mechanical analysis (DMA). In other words, the modulus may be used to characterize the crosslinked density. For example, the storage modulus of the first portion 20A is greater than 2×10⁵, and the storage modulus of the second portion 20B is less than 9×10⁴. As a result, the crosslinked density of the first portion 20A of the composite PSA 20 is greater than the crosslinked density of the second portion 20B. In one embodiment, the storage modulus of the first portion 20A is 2×10⁵−9×10⁵, and the storage modulus of the second portion 20B is 2×10⁴−9×10⁴, under modulus detection in the dynamic mechanical analysis (DMA) at 80-85° C.

Accordingly, the crosslinked densities of the first portion 20A and the second portion 20B of the composite PSA 20 may be controllably adjusted by modifying their modulus. Alternatively, the crosslinked densities of the first portion 20A and the second portion 20B of the composite PSA 20 may be controllably adjusted by modifying their molecular weight or glass transition temperature (Tg). For example, the crosslinked density may be increased, by increasing the molecular weight or the glass transition temperature. In one embodiment, the molecular weight of the first portion 20A is above 60000, and the molecular weight of the second portion 20B is below 30000; the glass transition temperature of the first portion 20A is −50 to −20° C., and the glass transition temperature of the second portion 20B is −60 to −30° C.

Generally speaking, increasing the crosslinked density will increase cohesive but decrease wettability, peel strength and stress relaxation capacity. On the other hand, decreasing the crosslinked density will decrease cohesive but increase wettability, peel strength and stress relaxation capacity. The relationship between the crosslinked density and the peel strength is described in a disclosure entitled “Crosslinked Acrylic Pressure-Sensitive Adhesives. I. Effect of the Crosslinking Reaction on the Peel Strength,” Journal of Applied Polymer Science, Vol. 87, 1493-1499 (2003), by Junko Asahara, the disclosure of which is hereby incorporated by reference.

Take the specific embodiment of FIG. 20 as an example, as the first portion 20A bonded to the plastic-based layer 21 (such as a polarizer) has a greater crosslinked density, it thus can relieve shear force caused by shrinkage or deformation from transferring to the interface between the composite PSA 20 and the glass layer 22, thereby eliminating the occurrence of stretching bubbles. Further, as the first portion 20A has greater cohesive, it can block low molecular-weight substance or outgassing substance from entering the composite PSA 20, thereby preventing from, destroying its net structure in optical adhesive or causing de-lamination.

On the other hand, as the second portion 20B bonded to the glass layer 22 has a lower crosslinked density, it thus has better wettability and adhesion and is capable of inhibiting the shear force of the plastic-based layer 21 from dragging the interface between the composite PSA 20 and the glass layer 22, thereby preventing the occurrence of mura phenomenon. Moreover, in another example, as the second portion 20B has better wettability, it thus can effectively fill the contour difference of an ink layer, thereby preventing the occurrence of bubbles.

The thickness of the first portion 20A and the second portion 20B of the composite PSA 20 may be determined according to respective applications. In one embodiment, the total thickness of the composite PSA 20 is primarily determined on the thickness of the second portion 20B, which has a thickness of about 100-500 μm, and the first portion 20A has a thickness of about 10-25 μm. The first portion 20A and the second portion 20B may be made of material of, but not limited to, acrylic-based PSA, rubber-based PSA or silicon-based PSA.

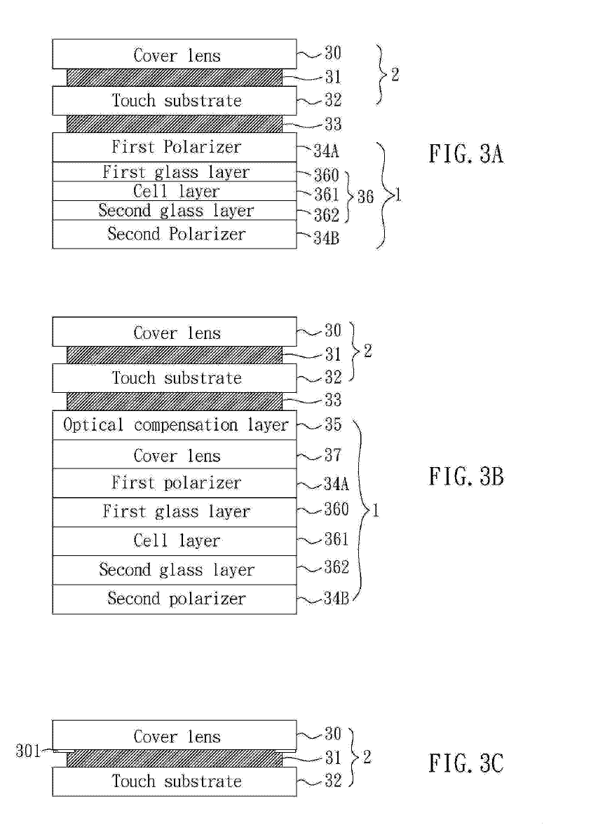

FIG. 3A show a side-view stacking diagram of a touch-display screen according to a first exemplary application of the present invention. In the exemplary application, the touch-display screen includes a cover lens 30, a touch substrate 32, a first polarizer 34A, a display module 36 and a second polarizer 34B. Specifically, the first polarizer 34A, the second polarizer 34B and the display module 36 form a display apparatus 1, which may be, but not limited to, a liquid crystal display (LCD), an organic light-emitting diode (OLED) display or an electroluminescent (EL) display. The display module 36 includes a first glass layer 360, a cell layer 361 and a second glass layer 362, where the first glass layer 360 and the second glass layer 362 are disposed at two outer sides and adjacent to the first polarizer 34A and the second polarizer 34B respectively, and the cell layer 361 is disposed between the fist/second glass layers 360/362. Take the LCD as an example, the first glass layer 360 may be a color filter (CF) layer and the second glass layer 362 may be an array layer. Further, the cover lens 30 and the touch substrate 32 form a touch module 2.

In the exemplary application, the cover lens 30 may be made of glass or plastic, and the touch substrate 32 may be made of glass or plastic. If the cover lens 30 and the touch substrate 32 have heterogeneous materials (i.e., one is glass and the other is plastic), a first PSA 31 between the cover lens 30 and the touch substrate 32 may employ the composite PSA of the embodiment; otherwise, the conventional PSA may be used. Similarly, if the touch substrate 32 is made of glass, a second PSA 33 between the touch substrate 32 and the first polarizer 34A may employ the composite PSA of the embodiment; otherwise, the conventional PSA may be used The composition of the composite PSA and its usage may be referred to FIG. 2A through FIG. 2C and their associated descriptions.

FIG. 3B shows a side-view stacking diagram of a detailed touch-display screen according to the first exemplary application of the present invention. The display apparatus 1 includes, in the order from top to bottom, an optical compensation layer 35, a cover lens 37, a first polarizer 34A, a first glass layer 360, a cell layer 361, second glass layer 362 and a second polarizer 34B. For brevity, PSA layers disposed among these layers are omitted.

FIG. 3C shows a side-view stacking diagram of a touch apparatus 2 according to the first exemplary application of the present invention. When the composite PSA is employed as the first PSA 31, it is capable of effectively fill the contour difference of an ink layer 301 because of better wettability on the cover lens 30, thereby preventing the occurrence of bubbles.

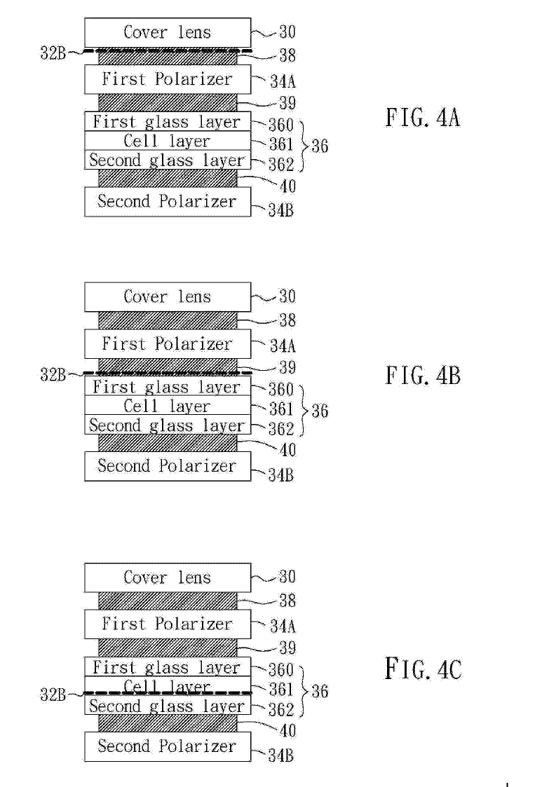

FIG. 4A shows a side-view stacking diagram of a touch-display screen according to a second exemplary application of the present invention. The composing layers being the same as those in the first exemplary application are denoted with the same numerals. The second exemplary application is similar to the first exemplary application with the distinctness that the touch substrate 32 is replaced with a touch layer 32B (such as an Indium Tin Oxide (ITO) layer) that originally should be disposed on the touch substrate 32 but is disposed instead on a bottom surface of the cover lens 30 (i.e., the surface facing the top surface of the first polarizer 34A). This structure may be named a touch-on-lens display apparatus.

In the second exemplary application, if the cover lens 30 is made of glass, a third PSA 38 between the cover lens 30 and the first polarizer 34A may employ the composite PSA of the embodiment; otherwise, the conventional PSA may be used. A fourth PSA 39 between the first polarizer 34 and the display module 36 may employ the composite PSA. Moreover, a fifth PSA 40 between the second polarizer 34B and the display module 36 may employ the composite PSA.

FIG. 4B shows a side-view stacking diagram of a first alternative exemplary application in place of FIG. 4A, with the distinctness that the touch layer 32B is disposed on a top surface of the display module 36 (i.e., the surface facing the bottom surface of the first polarizer 34A). This structure may be named a on-cell display apparatus.

FIG, 4C shows a side-view stacking diagram of a second alternative exemplary application in place of FIG. 4A, with the distinctness that the touch layer 32B is disposed inside the display module 36 (e.g., on the second glass layer 362 facing the cell layer 361). This structure may be named a in-cell display apparatus.

Although specific embodiments have been illustrated, and described, it will be appreciated by those skilled in the art that various modifications may be made without departing from the scope of the present invention, which is intended to be limited, solely by the appended claims.

What is claimed is:

1. An optical level composite pressure-sensitive adhesive (PSA), comprising:
a first portion; and
a second portion having a crosslinked density less than a crosslinked density of the first portion, wherein the first portion and the second portion together form a mono-composite structure;
wherein the first portion and the second portion may be bonded to a first lamination layer and a second lamination layer respectively that are heterogeneous to each other.

2. The PSA of claim 1, wherein the first portion has a modulus greater than a modulus of the second portion.

3. The PSA of claim 2, wherein a storage modulus of the first portion is 2×10⁵−9×10⁵, and a storage modulus of the second portion is 2×10⁴−9×10⁴, under modulus detection in a dynamic mechanical analysis (DMA) at 80-85° C.

4. The PSA of claim 2, wherein a storage modulus of the first portion is greater than 2×10⁵, and the storage modulus of the second portion is less than 9×10⁴.

5. The PSA of claim 1, wherein molecular weight of the first portion is greater than molecular weight of the second portion.

6. The PSA of claim 5, wherein the molecular weight of the first portion is above 60000, and the molecular weight of the second portion is below 30000.

7. The PSA of claim 1, wherein a glass transition temperature (Tg) of the first portion is higher than a glass transition temperature of the second portion.

8. The PSA of claim 1, wherein the first portion has a thickness smaller than a thickness of the second portion.

9. The PSA of claim 8, wherein the first portion has the thickness of about 10-25 μm, and the second portion has the thickness of about 100-500 μm.

10. The PSA of claim 1, wherein the first portion and the second portion are made of material of acrylic-based PSA, rubber-based PSA or silicon-based PSA.

11. The PSA of claim 1, wherein the first lamination layer is a non-glass layer, and the second lamination layer is a glass layer.

12. The PSA of claim 11, wherein the first lamination is a plastic-based layer, and the second lamination layer is a glass layer.

13. An apparatus with an optical level composite pressure sensitive adhesive, the apparatus being adapted as a touch apparatus, comprising:
a touch substrate;
a cover lens disposed above the touch substrate; and
a composite pressure-sensitive adhesive (PSA) bonded between the cover lens and the touch substrate;
wherein the composite PSA includes a first portion and a second portion that together form a mono-composite structure, and the first portion has a crosslinked density greater than a crosslinked density of the second portion.

14. The apparatus with the optical level composite pressure-sensitive adhesive of claim 13, wherein one of the cover lens and the touch substrate is a glass layer and the other is a plastic-based layer, wherein the first portion of the composite PSA is bonded to the plastic-based layer, and the second portion of the composite PSA is bonded to the glass layer.

15. The apparatus with the optical level, composite pressure-sensitive adhesive of claim 13, further comprising an ink layer disposed on a surface of the cover lens facing the touch substrate.

16. An apparatus with an optical level composite pressure-sensitive adhesive, the apparatus being adapted as a display apparatus, comprising:
at least one polarizer;
a display module including at least one glass layer and a cell layer; and
at least one composite pressure-sensitive adhesive (PSA) bonded between the polarizer and the display module;
wherein the composite PSA includes a first portion and a second portion that together form a mono-composite structure, and the first portion has a crosslinked density greater than a crosslinked density of the second portion; and
wherein the first portion is bonded to the polarizer and the second portion is bonded to the display module.

17. The apparatus with the optical level composite pressure-sensitive adhesive of claim 16 is a liquid crystal display (LCD), an organic light-emitting diode (OLED) display or an electroluminescent (EL) display.

18. The apparatus with the optical level composite pressure-sensitive adhesive of claim 16, wherein the at least one polarizer comprises a first polarizer and a second polarizer.

19. The apparatus with the optical level composite pressure-sensitive adhesive of claim 18, wherein the at least one glass layer comprises a first glass layer and a second glass layer, wherein the first glass layer is adjacent to the first polarizer, the second glass layer is adjacent to the second polarizer, and the cell layer is disposed between the first glass layer and the second glass layer.

20. The apparatus with the optical level composite pressure-sensitive adhesive of claim 19, further comprising a cover lens and another PSA, wherein the first polarizer is disposed between the first glass layer and the cover lens, and said another PSA, is bonded between the first polarizer and the cover lens.

21. The apparatus with the optical level, composite pressure-sensitive adhesive of claim 19, further comprising an optical compensation layer, wherein the cover lens is disposed between the first polarizer and the optical compensation layer.

22. The apparatus with the optical level, composite pressure-sensitive adhesive of claim 16, further comprising:
a cover lens; and
a touch layer disposed on a surface of the cover lens that faces the polarizer, thereby forming a touch-on-lens display apparatus.

23. The apparatus with the optical level composite pressure-sensitive adhesive of claim 16, further comprising a touch layer disposed on a surface of the display module that faces the polarizer, thereby forming an on-cell display apparatus.

24. The apparatus with the optical level composite pressure-sensitive adhesive of claim 16, further comprising a touch layer disposed in the display module, thereby forming an in-cell display apparatus.

25. An apparatus with an optical level composite pressure-sensitive adhesive, the apparatus being adapted as a touch-display screen, comprising:
a touch apparatus;
a display apparatus; and
a composite pressure-sensitive adhesive (PSA) bonded between the touch apparatus and the display apparatus;
wherein the composite PSA includes a first portion and a second portion that together form a mono-composite structure, and the first portion has a crosslinked density different from a crosslinked density of the second portion.

26. The apparatus with the optical level composite pressure-sensitive adhesive of claim 25, wherein the touch apparatus comprises:
a cover lens; and
a touch substrate disposed below the cover lens and above the display apparatus.

27. The apparatus with the optical level composite pressure-sensitive adhesive of claim 25, wherein the display apparatus comprises:
a first polarizer;
a second polarizer;
a first glass layer;
a cell layer; and
a second glass layer, wherein the first glass layer is adjacent to the first polarizer, the second glass layer is adjacent to the second polarizer, and the cell layer is disposed between the first glass layer and the second glass layer.
